(19) United States
(12) Patent Application Publication
(10) Pub. No.: US 2025/0212153 A1
(43) Pub. Date: Jun. 26, 2025

(54) COMMON COORDINATES FOR DEVICE LOCALIZATION

(71) Applicant: APPLE INC., Cupertino, CA (US)

(72) Inventors: Hollie R. Figueroa, Cupertino, CA (US); Jonathan R. Schoenberg, Fishers, IN (US); Hyojoon Bae, San Jose, CA (US); Rafi Vitory, Herzliya (IL)

(73) Assignee: APPLE INC., Cupertino, CA (US)

(21) Appl. No.: 18/783,140

(22) Filed: Jul. 24, 2024

Related U.S. Application Data
(60) Provisional application No. 63/535,527, filed on Aug. 30, 2023.

(51) Int. Cl. H04W 64/00; G06T 7/73

(52) U.S. Cl. CPC H04W 64/00; G06T 7/74; G06T 2207/10016; G06T 2207/30244

(57) ABSTRACT

Techniques may include capturing a sequence of images of an environment using a camera of the mobile device. Techniques may also include generating a map of an environment using the sequence of images, the map including one or more walls and one or more signal sources. Techniques may furthermore include receiving one or more proximity messages from the one or more signal sources. Techniques may in addition include determining a position for the mobile device using the map of the environment and the one or more proximity messages. Other embodiments of this aspect include corresponding methods, computer systems, apparatus, and computer programs recorded on one or more computer storage devices, memories, or non-transitory computer readable media each configured to perform the actions of the techniques.

### CROSS-REFERENCES TO OTHER APPLICATIONS

This application claims priority to U.S. Provisional Application No. 63/535,527, for “COMMON COORDINATES FOR DEVICE LOCALIZATION” filed on Aug. 30, 2023, which is herein incorporated by reference in its entirety for all purposes.

### BACKGROUND

Ranging measurements can be used to determine a device's location in an environment. Ranging measurements can be prone to uncertainty that can make it challenging to determine a device's location in some circumstances. Additionally, it is difficult to know the exact spatial coordinates of a location using typical ranging techniques. Accordingly, improvements to localization techniques are desirable.

### SUMMARY

In one aspect, techniques may include capturing a sequence of images of an environment using a camera of the mobile device. Techniques may also include generating a map of an environment using the sequence of images. Techniques may furthermore include identifying a set of signal sources in the environment using one or more of the sequence of images and proximity messages, where the proximity messages are exchanged between the mobile device and the set of signal sources. Techniques may in addition include assigning spatial coordinates within the map to each of the set of signal sources to generate a source constellation of relative positions of the set of signal sources. Techniques may moreover include storing the source constellation for access by one or more other mobile devices. Other embodiments of this aspect include corresponding methods, computer systems, apparatus, and computer programs recorded on one or more computer storage devices, each configured to perform the actions of the techniques.

Implementations may include one or more of the following features. Techniques may include: locating the mobile device using the source constellation by exchanging proximity messages with the one or more signals sources.

In one aspect, computer implemented techniques may include capturing a sequence of images of an environment using a camera of the mobile device. Techniques may also include generating a map of an environment using the sequence of images, the map including one or more walls and one or more signal sources. Techniques may furthermore include receiving one or more proximity messages from the one or more signal sources. Techniques may in addition include determining a position for the mobile device using the map of the environment and the one or more proximity messages. Other embodiments of this aspect include corresponding methods, computer systems, apparatus, and computer programs recorded on one or more computer storage devices, each configured to perform the actions of the techniques.

In one general aspect, techniques may include receiving a device constellation corresponding to a location from another device, where the device constellation is of relative positions of a set of signal sources. Techniques may also include receiving proximity messages from two or more signal sources. Techniques may furthermore include determining a position in the location for the first mobile device using the device constellation and the received proximity messages. Other embodiments of this aspect include corresponding methods, computer systems, apparatus, and computer programs recorded on one or more computer storage devices, each configured to perform the actions of the techniques.

Implementations may include one or more of the following features. Techniques can include embodiments where the device constellation was previously generated by a second mobile device at the location. Implementations of the described techniques may include hardware, a method or process, a computer tangible medium, a system, a non-transitory computer readable medium, a computing device, etc.

Other embodiments are directed to systems, portable consumer devices, and computer readable media associated with techniques described herein. A better understanding of the nature and advantages of embodiments of the present disclosure may be gained with reference to the following detailed description and the accompanying drawings.

### BRIEF DESCRIPTION OF THE DRAWINGS

FIG. 1A is a simplified diagram illustrating a plurality of physical positions in physical space.

FIG. 1B is a simplified diagram illustrating a plurality of sensor positions in sensor space according to various embodiments.

FIG. 2 is a simplified diagram of a technique for performing simultaneous localization and mapping according to various embodiments.

FIGS. 3A-3D are simplified diagrams depicting devices performing simultaneous localization and mapping techniques according to various embodiments.

FIG. 4A is a simplified diagram showing an overhead view of a physical space according to various embodiments.

FIG. 4B is a simplified diagram showing an overhead view of a physical space according to various embodiments.

FIG. 5 is a flowchart illustrating a method for performing spatial localization with a visual-inertial odometry (VIO) enabled device according to various embodiments.

FIG. 6 is a simplified sequence diagram showing the creation storage and use of a device constellation according to various embodiments.

FIG. 7 is a flowchart illustrating a method for determining a device constellation according to various embodiments.

FIG. 8 is a flowchart illustrating a method for performing antenna tuning according to various embodiments.

FIG. 9 is a block diagram of an example device according to various embodiments.

### DETAILED DESCRIPTION

The accuracy of ranging measurements can be improved by determining the relative positions of the signal sources (e.g., anchor devices) with respect to each other. These relative positions, which can be represented as vectors between the signal sources, can be used to resolve ambiguous ranging measurements. The relative positions of the signal sources can be determined using visual internal odometry (VIO). The relative positions can be shared among devices in such a manner so as not to divulge any images (i.e., using VIO) used to determine the relative positions.

A mobile device can use simultaneous localization and mapping (SLAM) techniques, in conjunction with VIO techniques, to generate a map of an environment. Localization using the map can be accurate, but SLAM techniques can be computationally demanding and may reduce the device's battery life. Instead, the locations and relative positions of the signal sources can be identified in the map to create a device constellation. This device constellation can be used to improve the accuracy of the ranging measurements so that a mobile device can be located accurately in a computationally efficient manner. This device constellation can be shared with other devices, including devices that are not capable of VIO or SLAM techniques, so that other devices can use the constellation during device localization.

### I. Sensor Measurements and Clusters

While a mobile device is positioned at a physical location within a dwelling (e.g., a home or building) or other location region, the mobile device can track its location by measuring signals emitted from one or more signal sources existing at that point in physical space. The mobile device may continuously track its location, track its location at regular intervals, or location tracking can be in response to a triggering event. For instance, the mobile device may detect a button press, which acts as a triggering event and causes the mobile device to measure signals (e.g., Wi-Fi, Bluetooth (BT), Bluetooth Low Energy (BLE), ultrawideband (UWB), Zigbee, etc.) emitted from any signal source, e.g., electronic devices, such as a wireless router, a Wi-Fi equipped appliance (e.g., set top box, smart home device), or a Bluetooth device. The detected signals may be used to generate a multi-dimensional data point of sensor values in sensor space, where each dimension in sensor space can correspond to a property of a signal emitted from a signal source. The multi-dimensional data point may represent the sensor position of the mobile device in sensor space, where the sensor position corresponds to the physical position of the mobile device in physical space.

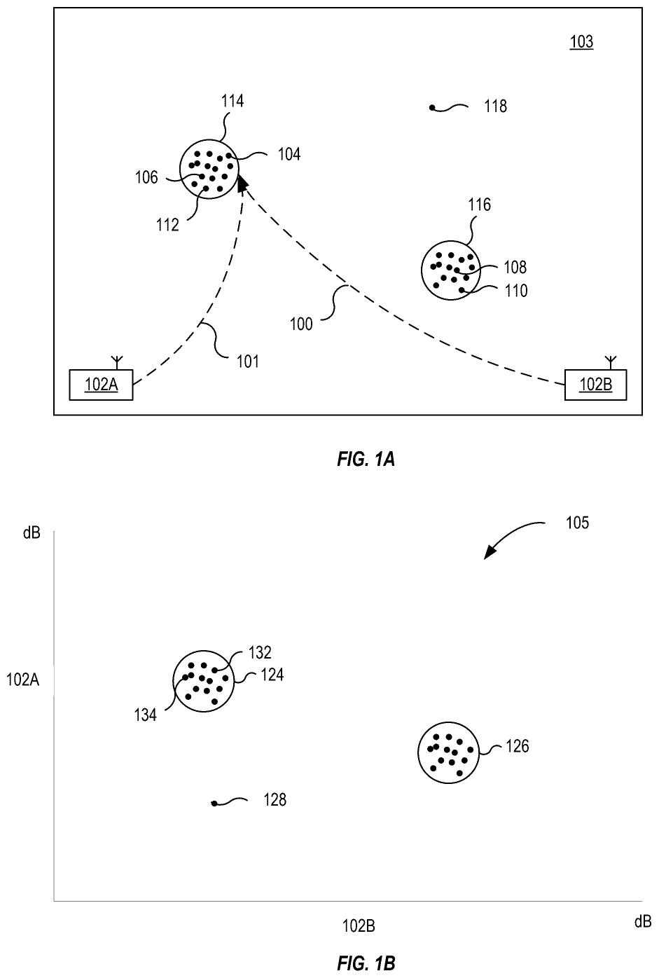

FIG. 1A is a simplified diagram illustrating a plurality of physical positions in physical space 103. As examples, physical space 103 can be the interior of a home, an office, a store, or other building. Physical space 103 may include a plurality of signal sources, such as signal sources 102A and 102B. Each signal source can emit wireless communication signals (e.g., ranging messages), as are emitted from a wireless router or a Bluetooth device. A signal source can be considered a stationary device, as their position does not typically change.

A “cluster” corresponds to a group of sensor positions (e.g., scalar data points, multi-dimensional data points, etc.) at which measurements have been made. Sensor positions can be determined to lie in a cluster according to embodiments described herein. For example, the sensor positions of a cluster can have parameters that are within a threshold distance of each other or from a centroid of a cluster. When viewed in sensor space, a cluster of sensor positions appears as a group of sensor positions that are close to one another. A cluster of sensor positions can be located, for example, in a room of a house or in a particular area (e.g., hallway, front door area) of a house.

A specified location in a house or building can also be referred to as a “microlocation.” A location can be referred to as a microlocation because the location refers to a specific area in, for example, the user's home. In addition, a location or microlocation can also be referred to as a cluster of locations. The following terms: sensor space location, microlocation, and cluster of locations may refer to a same area or region. A home may have a number of locations. A location can correspond to a room in a house, a portion of a room, or other areas in a house. For example, a location can be a backyard area, a front door area or a hallway area. A location may refer to an area outside of a house such as a porch, a backyard, a parking spot, or other outdoor areas.

A mobile device may be located within physical space 103 such that one or more signals emitted from signal sources 102A and 102B are detected. For example, the mobile device may be located at physical position 104 in FIG. 1A, where signals 101 and 100 are detected from signal sources 102A and 102B, respectively. It is to be appreciated that the mobile device may only measure one of signals 101 and 100 at some positions, e.g., due to signal degradation at certain positions. Furthermore, the mobile device can be at a physical position where signals from other signal sources (not shown) that are outside of physical space 103 can be detected, and that techniques herein are not limited to physical positions where the mobile device can only detect signals 101 and 100.

Typical human behavior results in the mobile device being used in some physical locations more often than other physical locations. For example, a user may use a mobile device more often when the user is on a couch or in a bed. These physical locations may be represented by clusters of physical positions, such as clusters 114 and 116 of physical positions. Each cluster may have a group of physical positions that are located close together. As an example, cluster 114 may include physical positions 104, 106, and 112. As shown, cluster 116 includes physical positions 108 and 110. The mobile device may be configured to determine when the mobile device is in one of these clusters based on the detected signals (e.g., signals 100 and 101) and identify an application that is associated with the cluster.

As part of detecting signals at any of the physical positions using sensor(s) of the mobile device, the mobile device may measure one or more sensor values from signals emitted from signal sources 102A and 102B. For instance, if the mobile device is at physical position 104, the mobile device may measure sensor values from signal 101 emitted from signal source 102A and signal 100 from signal source 102B. The measured sensor values may be signal properties of signal 101 and signal 100. The measured sensor values may be used to form a sensor position in sensor space, as shown in FIG. 1B.

FIG. 1B is a simplified diagram illustrating a plurality of sensor positions in sensor space 105, which corresponds to physical space 103. Sensor space 105 is depicted as a plot of measured sensor positions in signal strength. The X axis may represent measured values of signals from signal source 102B in dB increasing to the right, and the Y axis may represent measured values of signals from signal source 102A in dB increasing upwards. Although FIG. 1B illustrates an example in which the sensor space has two dimensions (e.g., sensor values from signals from signal source 102A and signal source 102B, respectively), a sensor space can include more or fewer dimensions.

The sensor positions in sensor space correspond to respective physical positions in physical space 103. For example, measured sensor values at physical position 104 in FIG. 1A corresponds to a sensor position 132 in sensor space shown in FIG. 1B. Sensor position 132 is represented as a two-dimensional data point where one dimension corresponds to a sensor value from signal source 102A and the other dimension corresponds to a sensor value from signal source 102B. Sensor space 105 may include clusters of sensor positions, e.g., cluster 124 of sensor positions and cluster 126 of sensor positions. Clusters 124 and 126 of sensor positions correspond with clusters 114 and 116 of physical positions in FIG. 1A, respectively.

Clusters 124 and 126 may be unlabeled locations, meaning the mobile device does not know the actual physical coordinates corresponding to clusters 124 and 126. The device may only know that there exists a cluster of sensor positions that have similar sensor values and that the cluster represents a discrete location in physical space. However, the mobile device may perform functions based on sensor positions in sensor space such that use of the mobile device in physical space is benefitted. For instance, the mobile device may determine a sensor position of the mobile device and suggest an application to the user based on whether the sensor position is within a cluster in which pattern of application usage is known. Method of forming clusters and suggesting an application according to a sensor position are further discussed below.

Accordingly, a sensor position can correspond to a set of one or more sensor values measured by sensor(s) of a mobile device at a physical position in physical space from one or more wireless signals emitted by one or more signal sources (e.g., external devices such as networking devices). A sensor value can be a measure of a signal property, e.g., signal strength, time-of-flight, or data conveyed in a wireless signal, as may occur if a signal source measures a signal property from the mobile device and sends that value back to the mobile device. Each sensor value of a set can correspond to a different dimension in sensor space, where the set of one or more sensor values forms a data point (e.g., a multi-dimensional data point, also called a feature vector) in the sensor space.

In the example shown in FIG. 1A, sensor values for sensor positions in cluster 114 may be higher for signal source 102A (which is in the vertical axis in FIG. 1B) than the sensor values for sensor positions in cluster 116, e.g., when the sensor value is signal strength. This may be due to the fact that physical positions in cluster 114 are closer to signal source 102A than physical positions in cluster 116 are to signal source 102A. When the sensor value is a signal property of time-of-flight, the values for cluster 114 would be smaller than for cluster 116.

A given measurement of the one or more wireless signals obtained at a physical position may be made one or more times over a time interval to obtain a set of sensor value(s). Two measurements at two different times can correspond to a same sensor position, e.g., when the two measurements are made at a same physical position at the two different times. A sensor position can have a value of zero for a given dimension, e.g., if a particular wireless signal is not measured, or have a nominal value, e.g., in case of low signal power (−100 decibels (dB) received signal strength indication (RSSI)) or have an uncertainty that is large.

Groups of sensor positions having similar parameters may form a cluster, which can be used to define a discrete location. One or more clusters may be used to identify an application or an accessory device to suggest to a user in, for example, a message (e.g., display on a screen or an audio message).

Applications and/or accessory devices can be associated with the one or more clusters. Specifically, applications and accessory devices can be associated with a particular location of the mobile device. A location that refers to a specific area in a user's home can be referred to as a microlocation. A microlocation can also be referred to as a cluster of locations. The following terms: location, microlocation, and cluster of locations may refer to a same area or region. A location can correspond to a room in a house or other areas in a house. For example, a location can be a backyard area, a front door area or a hallway area. Although a home is used as an example, any area or room in which accessory devices are located can be used in determining a cluster of locations.

### II. Use of Visual Inertial Odometry for Slam

Microlocations can be difficult to distinguish using sensor signals alone. Interior spaces within a building can be separated by walls, furniture, and other design elements. These design elements can visually separate two distinct microlocations. However, these two microlocations may be too close in sensor space for a distinction to be drawn between the locations.

The path between two locations in physical space may be longer than the distance in sensor space. A signal may not detect an interior wall separating two physical positions that are one meter apart. For example, an ultrawideband signal may pass through an interior drywall without losing a distinguishable amount of signal strength. Accordingly, the two positions may appear to be a single microlocation in signal space. However, the two locations may be easily distinguished in physical space because the physically accessible path between these two positions may involve a ten-meter trip around the wall. Simultaneous localization and mapping techniques, performed using visual inertial odometry, can be used to generate a map of the environment that can be used to distinguish the two locations.

### A. VIO Overview

The movement of a device in physical space, and the visual features of each microlocation, can be determined with odometry techniques. Odometry can refer to techniques for a device to determine its location and movement in an environment. Odometry can be performed with motion sensors (e.g., a pedometer) and measurements from these sensors can be translated into movement within a physical environment. In addition or alternatively, odometry can be performed by comparing sequential camera frames (e.g., visual odometry).

A device using odometry techniques implemented with motion sensors (e.g., inertial odometry) can estimate the device's location and path relative to an initial position. Such techniques can be advantageous in some scenarios. Motion sensors are energy efficient, when compared to a camera, and calculating distances with a motion sensor is less computationally demanding than determining the device's position through visual odometry. For example, a rotary encoder can track a wheeled robot by counting wheel rotations, but the same robot using visual odometry would have to perform feature extraction on images for the duration of the robot's journey.

Visual odometry can track a device's location from the relative movement of objects as they are viewed from different perspectives (e.g., the parallax). To perform visual odometry, an initial image can be captured by a tracked device's camera, and features within this image can be identified by the tracked device's processor. The tracked device can repeatedly capture such images and extract features. The relative position of features in sequential images can be compared and used to calculate the tracked device's position.

Visual odometry techniques can be combined with inertial odometry techniques. This visual inertial odometry can compensate for some of the limitations of visual odometry and inertial odometry. Visual odometry is energy and computationally expensive, and visual odometry can be prone to errors where the device can lose track of its current position if the device is moved suddenly. This problem can be mitigated by increasing the frame rate of the camera, which reduces the distance the device's camera can move between frames. However, increasing the frame rate increases the computational and power load on the device because each image may have to be processed by the device. Inertial odometry can be good at detecting short sudden motion, but inertial sensor values are noisy, and the position determined by inertial odometry can drift over long distances. These limitations can be managed through visual inertial odometry techniques.

Visual inertial odometry can determine a device's position using both inertial and visual inputs. Visual inertial odometry techniques can be classified as loosely-coupled or tightly-coupled. In loosely-coupled visual inertial odometry, the device's position is separately estimated using visual odometry techniques and inertial odometry techniques. These results are fused to produce a final estimation for the device's position. The results can be fused using a filter such as an Unscented Kalman Filter (UKF) or an Extended Kalman Filter (EKF). In tightly-coupled visual inertial odometry techniques, the inertial measurements and the inputs from the camera are input into a combined prediction framework that outputs an estimate for the device's position. For example, the inertial measurements can be used to predict the movement of visual features between camera frames reducing the search space for the visual features. Tightly-coupled visual inertial odometry can be performed with the following formula:

$$J ( x ) = {\sum }_{i = 1}^{I} {\sum }_{k = 1}^{K} {\sum }_{j ∈ J ( i , k )} {e}_{r}^{i , j , kT} {W}_{r}^{i , j , k} {e}_{r}^{i , j , k} + {\sum }_{k = 1}^{K - 1} {e}_{s}^{kT} {W}_{s}^{k} {e}_{s}^{k}$$

J(x) is a cost function, i is the camera index (e.g., for devices with multiple cameras), k is the frame index, and j represents the landmark index. J(i,k) represents the indices of the k^{th} frame in the i^{th} camera, eᵣ is a reprojection error term for the camera measurements, eₛ can be the temporal error term for the inertial measurements, Wₛ^{k} is the information index of the k^{th} inertial measurement error, and Wᵣ^{i,j,k} can represent the information matrix of a respective landmark measurement. Further details of the tightly-coupled visual inertial odometry techniques can be found in: Leutenegger, Stefan et al. “Keyframe-based visual-inertial odometry using nonlinear optimization”. In: The International Journal of Robotics Research 34.3 (2015), pp. 314-334.

### B. Simultaneous Localization and Mapping

Simultaneous localization and mapping (SLAM) is the problem of generating a map of an environment while tracking a device's movement within this environment. SLAM techniques use odometry to determine a device's position, however, an important difference between odometry techniques and SLAM is loop closure. A device performing odometry can view the device's path through the environment as a journey down an endless hallway. Even though the device may be traveling in a loop, and the device may have passed the same point repeatedly, a device performing odometry techniques, without loop closure, will treat each point in the environment as new. As a result, errors and drift in a the odometry techniques can accumulate over time.

Loop closure is the process of determining that the device has returned to a previously documented location. As discussed above, visual odometry techniques can be performed by detecting and comparing features in sequential images. Loop closure can be viewed as an extension of this process. Rather than determining if common features between sequential images, the device can maintain a log of the features visited during the device's journey in the environment. The device can recognize that a feature in a current image was present in a previously encountered image. This recognition can be used to “close the loop” because the device must have returned to the same location where the feature was first encountered. The common points of reference constrain the shape of the device's journey and this constraint can be used to correct for errors and drift in the odometry measurements.

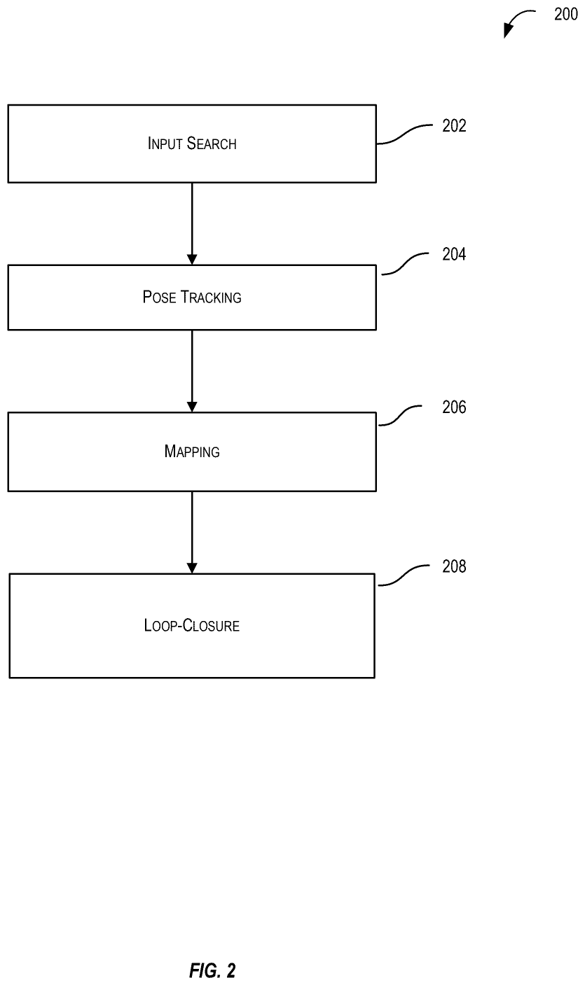

FIG. 2 is a simplified diagram of a technique 200 for performing simultaneous localization and mapping according to various embodiments. SLAM techniques are described in greater detail in: Myriam Servières, Valérie Renaudin, Alexis Dupuis, Nicolas Antigny, “Visual and Visual-Inertial SLAM: State of the Art, Classification, and Experimental Benchmarking”, Journal of Sensors, vol. 2021, Article ID 2054828, 26 pages, 2021. https://doi.org/10.1155/2021/2054828.

At block 202, an input search is performed. Input search can be the process of gathering information from camera frames captured by the device (e.g., the input). Input search techniques can be direct or indirect. In direct input search techniques, the pixel intensity of each image can be used as input. Direct techniques can be quick, but such techniques are potentially noisy. Indirect input search techniques can be slower than direct techniques, but the techniques can create input that is more robust to noise. Indirect input search techniques can involve extracting features from images and using those extracted features as input. If the SLAM techniques are implemented with visual inertial odometry, the input search can involve measuring inertial data from device sensors. The input search, and the other steps in this technique can be performed in parallel for the duration of the SLAM procedure.

At block 204, the pose tracking can be performed. Pose tracking can be the process of determining a device's position and orientation in an environment. Pose tracking can be performed using visual odometry or visual inertial odometry techniques. In pose tracking, the input from sequential camera frames can be compared and the device's position can be estimated from the apparent movement of features within the sequential frames.

At block 206, mapping of the environment can be performed. Mapping can be the process of using the inputs from 202 to create a three-dimensional reconstruction of the environment. For indirect inputs, a vector can be generated between two features in a frame. Vectors can be generated for the same two points in sequential images and an intersection between vectors from different images can be determined. For direct inputs, a depth value can be assigned to each pixel in a frame to create a depth map. This depth value can be a ray traced through the pixel that represents a range of possible depths for this pixel. Points of overlap between two images can be determined and the two depth maps can be combined, or two depth maps can be fused to produce a map of the environment.

At block 208, loop closure can be performed. Loop closure can involve place recognition where features or pixels from one image are compared to the features or pixels from previous images. If a similarity between two images is determined, it is probable that the device is at the same place in both images and the map can be corrected. This correction can involve identifying the pose of the device in each image that is determined to be at the same place.

Technique 200 may include additional implementations, such as any single implementation or any combination of implementations described below and/or in connection with one or more other processes described elsewhere herein.

Although FIG. 2 shows example blocks of technique 200, in some implementations, technique 200 may include additional blocks, fewer blocks, different blocks, or differently arranged blocks than those depicted in FIG. 2. Additionally, or alternatively, two or more of the blocks of technique 200 may be performed in parallel.

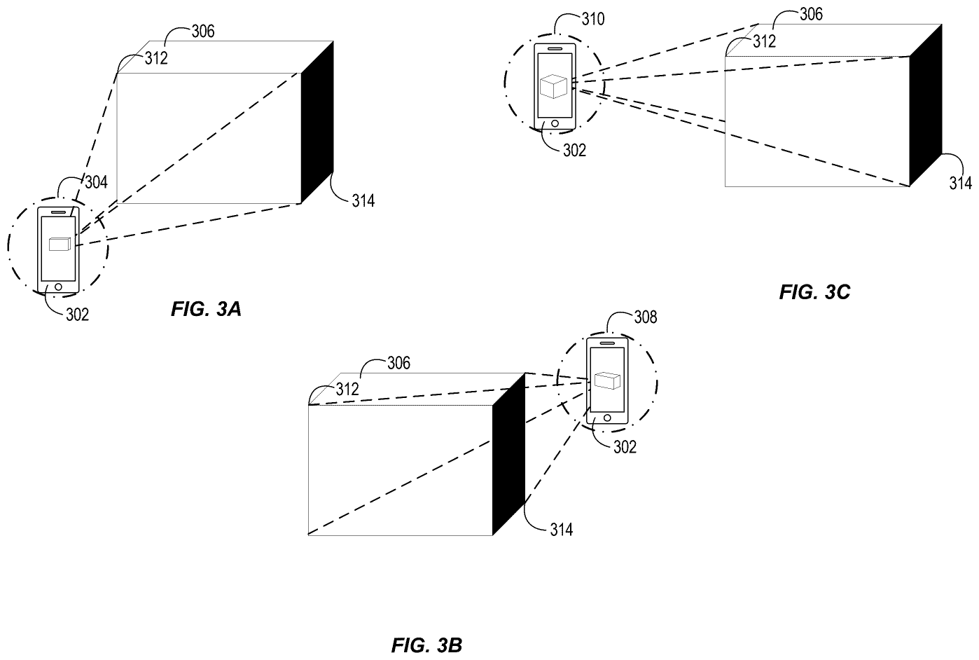

The simultaneous location and mapping techniques described above can be used to generate a map of an environment. This map can be a three-dimensional representation of an environment rather than a two-dimensional navigational map (e.g., a roadmap). A mobile electronic device can be used to generate such a map using simultaneous localization and mapping techniques. An illustrative example of map generation with a mobile device is described below with respect to FIG. 3.

FIGS. 3A-3C show simplified diagrams depicting a device performing simultaneous localization and mapping techniques according to various embodiments. In FIG. 3A, the electronic device 302 initiates a process for mapping and localizing device 302 with respect to the physical environment using, for example, a SLAM technique. The electronic device 302, at a first position 304, captures images of cube 304 via the image sensor (e.g., image sensor(s)) located on the electronic device 302. In some implementations, to determine its pose with respect to the physical environment, the electronic device 302 uses the captured images in combination with data obtained via additional sensor(s) (e.g., motion sensors, depth sensors, orientation sensors, etc.) and corresponding sensor parameters.

The electronic device 302 can detect notable features from the captured images (e.g., lines, segments, planes, points, or other three dimensional geometric elements and shapes such as edges or corners of cube 306 that are in the field of view of the image sensor) and the electronic device 302 can estimate the position of cube 306 in three dimensional space while also estimating its own pose by iteratively reducing or minimizing an error function for the three dimensional position and pose estimations using the captured images and data obtained via the image sensor and additional sensors. The electronic device 302 may create and store a keyframe that includes an image, positions of features in the image, or the image sensor pose associated with the image.

As shown FIG. 3B, the electronic device 302 is moved to a second position 308 in the physical environment during the localization and mapping process. While traversing from the first position 304 to the second position 308, the electronic device 302 can capture a sequence of images of cube 306. In each image of this sequence, the electronic device 302 can detect at least some of the features that were detected in the preceding image. For each image and by comparing the positions of the features in the captured images or incorporating data from additional sensor(s), the electronic device 302 updates its estimates for the three dimensional position of the features (e.g., position of a point in three dimensional space) and its own estimated pose with respect to the physical environment. The electronic device 302 may create and store keyframes that each include an image, positions of features depicted in the image, or the image sensor pose associated with the image. The features of such keyframes, image sensor pose information, and information from other sources (e.g., device motion detection data) can be used to determine a mapping that provides the relative positions of the keyframes to one another in a three dimensional coordinate space. In some implementations, the electronic device 302 performs SLAM by simultaneously determining its current pose (e.g., localization) and determining relative keyframe locations (e.g., mapping).

Turning now to FIG. 3C, electronic device 302 can continue to traverse around cube 306 until the device reaches a third position 310 with a field of view that overlaps with the device's field of view at the first position 304. Two fields of view can overlap if at least one feature can be identified in each field of view. For example, corner 312 can be a feature that is present in images captured at the first position 304 and the third position 310. Once common features have been identified, electronic device 302 can perform loop closure by associating an identifier for the feature corresponding to corner 312 in images captured at the first position 304 with an identifier for 312 in images captured at the third position 310.

During the device's traversal, each image captured by electronic device 302 contains a common feature with a preceding image. The movement of these features can be used by electronic device 302 to estimate the relative positions of these features in physical space. By performing loop closure, the uncertainty in these estimations is constrained because the feature in an image captured at the first position 304 must correspond to the position of that feature in an image captured at the third position 310. In addition, the correspondence between features captured in each image during the mobile device's traversal means that an image can be used to estimate the device's pose with respect to features not shown in the image. For instance, the relative position of corner 312 and corner 314 can be determined from the images captured during traversal, and, by estimating the mobile device's position to corner 312, the device's position with respect to corner 314 can also be determined.

III. Use of Spatial Map in Combination with Sensor Position

A spatial map generated using the SLAM techniques described above can be used to determine a location more precisely. The map can be used to differentiate between microlocations that may be closely located in sensor space. The device can track its movement through the environment form an origin using the map and the odometry techniques described above. In addition, the device can track its movement through sensor space by exchanging ranging messages (e.g., proximity messages) with signal sources. The ranging messages can be used to calculate a distance to the source of the ranging message (e.g., a ranging measurement). The device may encounter a scenario where the device has measured a set of ranging measurements that correspond to a physical location.

Upon detecting a potential cluster in sensor space, the mobile device can cross reference the ranging measurements against the device's map location where each ranging measurement was received. The map can include architectural features, like walls, that may not be noticeable in sensor space, and the device can determine the distance that the device would have to travel between the physical locations where each ranging measurement was received (e.g., the distance in physical space). Ranging measurements taken in the same physical location can be grouped as a cluster corresponding to that physical location while measurements taken in positions that are separated by a large distance in physical space can be treated as corresponding to separate physical locations.

### A. Identifying Corresponding Physical Space and Sensor Space Locations

A physical space map can be used to distinguish between sensor space clusters. Two sensor space clusters may be sufficiently close in sensor space that a mobile device may classify them as a single cluster. However, these clusters can be separated by a large distance in physical space. The mobile device can assign a corresponding physical location, in a SLAM map, to each received sensor values. This correspondence can be used to more accurately identify clusters corresponding to a physical location. After this correspondence has been established, the physical locations can be identified accurately using sensor values.

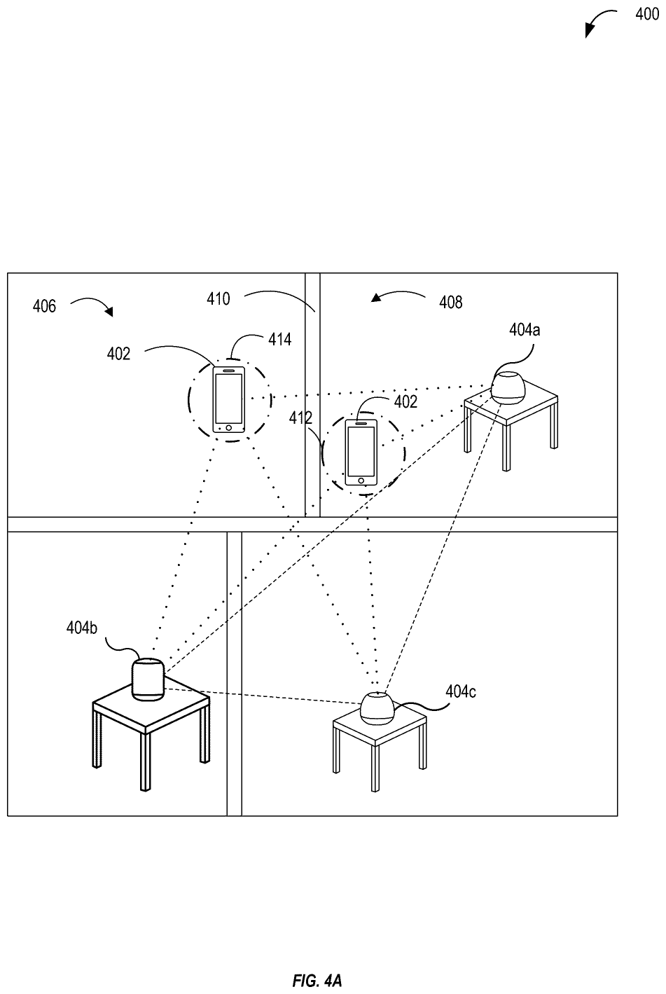

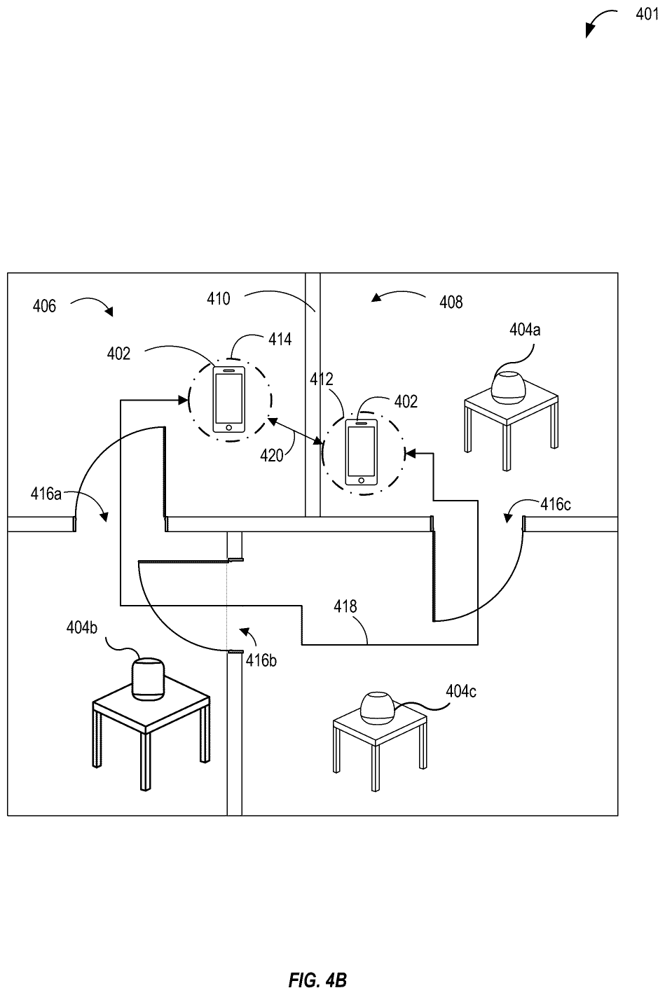

FIG. 4A is a simplified diagram 400 showing an overhead view of a physical space according to various embodiments. Device 402 can be a mobile device or any other device that is configured to exchange ranging messages (e.g., proximity messages) with signal sources 404a-404c. Ranging messages can be ultrawideband messages exchanged between the devices and a ranging message can be used to calculate sensor values such as ranging measurements including received signal strength indicator or time-of-flight measurements. The device 402 can be configured to generate a map of a physical space using the SLAM techniques disclosed above. For example, device 402 can be a smartphone, a tablet computer, a laptop computer, a wearable computer, etc. Signal sources 404a-404c can be any device that is configured to exchange ranging messages with other devices.

Device 402 can perform SLAM techniques to map the physical space depicted in FIG. 4. The point at which the mobile device begins to perform SLAM techniques can be an origin for the map and the distances on the map can be measured relative to this position (e.g., the origin can be (0, 0, 0,) in a three-dimensional cartesian coordinate system). During this mapping procedure, device 402 may identify physical locations of signal sources 404a-404c. The physical locations of the signal sources can be identified using a model that recognizes and identifies identifying characteristics of the signal sources 404a-404c in images captured by device 402. These images can be captured while device 402 is performing SLAM techniques. For example, the device may recognize the shape of an external housing for each of the signal sources 404a-404c or the device may recognize visually identifiable information such as a linear barcode or matrix barcode on the surface of the signal sources 404a-404c. Once recognized, device 402 can use SLAM techniques to determine the signal source's position in the map.

In some embodiments, the images may be captured by a first device and a map may be generated by a second device. For example, the first device capturing the images may not be capable of generating the map. Accordingly, the device generating the map may not be located in the environment that is currently being mapped. For example, image can be captured by a wearable device (e.g., smart glasses) and the map can be generated by a remote server computer. In addition to images, the IMU measurements from the first device can be provided to the second device.

Ranging measurements can be used to help identify physical locations corresponding to signal sources. In some embodiments, device 402 can be exchanging ranging messages with the signal sources during the SLAM procedure, and a signal source may provide information identifying the signal source to the device 402. For example, the ranging measurements can include a device identifier corresponding to the device transmitting the ranging measurement. When device 402 determines that the device is at a signal source, the device can associate the location with the device identifier of the closest signal source 404a-404c. For example, signal source 404a and signal source 404c can have the same exterior appearance and it may not be possible to visually distinguish the two devices. Device 402 can distinguish the two sources using this identifying information because the device, at physical location 412, is closest to signal source 404a. Additionally, or alternatively, device 402 can determine the closest signal source 404a-404c in response to visually identifying a signal source. Device 402 can use a source identifier from the payload of a ranging message to determine which of signal sources 404a-404c is closest, and the visually identified signal source can be associated with the identifier.

Device 402 may identify the physical locations of the signal sources 404a-404c using a source location procedure. During this procedure, device 402 can be placed in close proximity with the signal sources while the device 402 is performing SLAM techniques. For example, the procedure could involve placing device 402 on top of each signal source and recording the location of the respective signal source in the map. Continuing the example, the location can be recorded in response to an indication that the device 402 is on top of the signal source (e.g., via a button press, graphical user interface input, verbal command, near-field communication signal, etc.).

Signal sources 404a-404c can exchange ranging messages with device 402. These ranging messages are indicated as dotted lines in FIG. 4. The device 402 can use these ranging messages to calculate sensor values that indicate the device' distance from the signal sources 404a-404c. For example, the device 402 can use the time-of-flight and received signal strength indicator measurements for the ranging messages to determine the distance between device 402 and signal source 404a. The device location can be used to identify microlocations in the physical environment. For example, if device 402 spends a sufficient amount of time in a particular sensor space location (e.g., the device is in a sensor space location for a period of time that exceeds a threshold), then the physical location corresponding to that sensor space location can be associated.

The signal sources 404a-404c may exchange ranging messages, and these messages are indicated in FIG. 4A as dashed lines between the sources. These messages can be used to improve the accuracy of ranging measurements between the signal sources 404a-404c and the device 402. The accuracy of the ranging measurements can be improved if the correspondence between a sensor space location and a physical space location are made more accurate. For example, the physical space locations of the signal sources 404a-404c can be known from SLAM map and source location procedures described above. Ranging messages, and the measurements calculated from those messages, can be prone to errors such as multipath errors for time-of-flight measurements and body blocking for received signal strength indicator measurements. However, because the position of the signal sources 404a-404c are known, the signal sources can exchange messages to calibrate the distance calculations from the ranging measurements.

Each signal source 404a-404c can calculate the distance (e.g., physical distance) to the other signal sources using ranging measurements and these calculated physical distances can be compared to the known distances from the SLAM map. The signal sources 404a-404c can calculate their distance relative to the origin of the map. The difference between the calculated distance from the ranging messages and the known physical distance from the SLAM map can be used to correct the calculated distance. For example, if the calculated distance is 10% shorter than the known distances, one of the signal sources 404a-404c can instruct the device 402 to adjust its calculated distances to compensate for this shortfall. The difference between the calculated and known distance can be included in ranging measurements sent by the signal sources 404a-404c so that a device receiving the message from a particular signal source can compensate for the known error for messages from that source.

Device 402 may not be able to distinguish between some physical locations using only ranging measurements. For example, ranging measurements may not have sufficient accuracy to determine if device 402 is in a first room 406 or a second room 408. The first room 406 and the second room 408 can be separated by a wall 410. The ranging messages between device 402 and the signal sources 404a-404c may be able to pass through the wall 410 without a noticeable difference in time-of-flight or signal strength so the device 402 may appear to be in the same location in signal space even though the device is receiving the messages at two separate physical locations (e.g., physical location 412 and physical location 414).

### B. Distinguishing Between Two Physical Locations

Physical locations may be difficult to distinguish in sensor space. Errors and uncertainty in sensor values can mean that the sensor values received at two separate physical locations may overlap. Additionally, two different physical locations may appear to be as a single cluster in sensor space. In such circumstances, a map of the physical space can be used to determine where a particular sensor value was received and the distance between physical locations. This information can be used to distinguish between physical locations.

FIG. 4B is a simplified diagram 401 showing an overhead view of a physical space according to various embodiments. The physical space shown in diagram 401 can be the same space shown in diagram 400 and the description of elements in diagram 400 can apply to similar features in diagram 401. In addition, elements shown in diagram 401 may have been omitted in diagram 400 in the interest of clarity. For example, doors 416a-416c are omitted in diagram 400 and shown in diagram 401.

Device 402 may struggle to distinguish between physical location 412 and physical location 414 because the two locations may appear similar in sensor space. Even if there may be a detectible difference between the sensor values at each location, there may be no suggestion to 402 that the sensor values corresponding to the two physical locations should be considered separate physical locations. Device 402 may detect sensor values that are separated by a short distance in sensor space and the device may categorize the two physical locations 422, 412 as one physical location.

Information obtained from a map of the physical space depicted in diagram 401 can be used to distinguish between physical location 412 and physical location 414. The known position of signal sources 404a-404c can result in more precise sensor space readings that may make the difference between physical location 412 and physical location 414 more detectable to device 402. The known positions can be three-dimensional coordinates within the physical space, and, as discussed above, the known positions can be used to calibrate the ranging messages between the devices. The known positions can calculated relative to the origin of the map (e.g., the position where the device that generated the map began to perform SLAM techniques). These calibrated ranging messages can mean that the ranging messages are sufficiently precise to distinguish between physical location 412 and physical location 414. Imprecise ranging measurements may mean that the sensor space representations of physical location 412 and physical location 414 overlap. Overlapping sensor space representations may be grouped into a single physical location. In contrast, more precise ranging measurements may mean that the sensor space representations of physical location 412 and physical location 414 appear separate and device 402 may identify physical location 412 and physical location 414 as separate physical locations.

As discussed above, device 402 can create a map of the physical space using SLAM techniques. This SLAM map, and the movement of device 402, can be used to determine that physical location 412 and physical location 414 are separate physical locations. Device 402 may record the device's position within the map (e.g., the device's physical location) as ranging messages from the signal sources 404a-404c are received. The physical location, and the location in sensor space, can be correlated for received ranging measurements. In addition, the path between physical locations can be determined using the SLAM map. For example, path 418 can be the path between physical location 412 and physical location 414. Two ranging measurements may only be grouped as part of a single physical location if the path between the two physical locations is within a threshold path length.

The path between two physical locations is not necessarily a linear distance between the two points, but a path between the two physical locations in physical space. The movement of device 402 within the map is constrained by physical objects such as wall 410. Device 402 cannot physically move along a linear distance 420 between physical location 412 and physical location 414. Instead, device 402 must move along path 418, through doors 416a-416c, to move between physical location 412 to physical location 414. Device 402 can calculate the path in physical space between physical locations, and the path lengths can be used to determine if a single cluster in signal space should be categorized as two separate clusters with each cluster corresponding to a different physical location. In addition, device 402 can use the location of detected objects to determine if a single cluster in signal space should be categorized as two separate clusters. For example, a detected wall within a cluster may indicate that the single cluster should be treated as two separate clusters.

In an illustrative example, physical location 412 may correspond to a couch in a living room. The back of the couch is against wall 410 and physical location 414 may correspond to a bed in a bedroom. The linear distance 420 between the two physical locations may be less than a meter, but the path 418 between the two physical locations may be 8 meters. Device 402 may compare the length of path 418 to a path threshold to determine if the sensor values corresponding to physical location 412 and the sensor values corresponding to physical location 414 correspond to the same physical location. The sensor values corresponding to the two physical locations may be classified corresponding to separate physical locations if the length of path 418 is above a threshold. In situations where multiple paths between physical location 412 and physical location 414 are possible, the shortest path may be compared to the threshold. In some embodiments, the most commonly navigated path, and not the shortest path, may be compared to the threshold.

The path threshold can be an absolute path length (e.g., 2 meters) or a comparison between the linear distance and the path length. The comparison can be a ratio of the path length 418 and the linear distance 420, and the path threshold can be a ratio of the path length divided by the linear distance. Physical locations can vary in size, and, for example, a cluster corresponding to a bathroom may be smaller than a cluster corresponding to the garage. Navigating within a single physical location may be approximately linear and the path from one side of the garage to the other side of the garage may approximately correspond to the linear distance between these two locations. In comparison, a path from the bathroom to the garage may not be linear because a device traveling this path through a house may have to navigate through a hallway and a living room before reaching the garage. Accordingly, the path threshold value may be a ratio of the path length divided by the linear distance.

Device 402 may use the map to assign a confidence score to particular sensor values received from sensor sources 404a-404c. For instance, device 402 may receive ranging measurements at physical location 412 and physical location 414. Device 402 can store each received message with a value indicating a physical location in physical space where the message was received. Each received message may have characteristics such as a time-of-flight and a received signal strength indicator. It is possible that messages with a first set of characteristics are only received at physical location 412, messages with a second set of characteristics are only received at physical location 414, and message with a third set of characteristics are received at both physical location 412 and physical location 414. Device 402 may assign a confidence score indicating a high likelihood that device 402 is at physical location 412 to messages with the first set of characteristics. Similarly, device 402 may assign a confidence score indicating a high likelihood that device 402 is at physical location 414. In addition, device 402 may assign a confidence score indicating a low likelihood that the device is at either physical location to messages with the third set of characteristics. A machine learning model may assign these confidence scores and the confidence score can be an n-dimensional vector where n is the number of identified microlocations in a particular environment and each physical location is assigned a probability that the message corresponds to that particular physical location.

C. Spatial Localization with a VIO Enabled Device

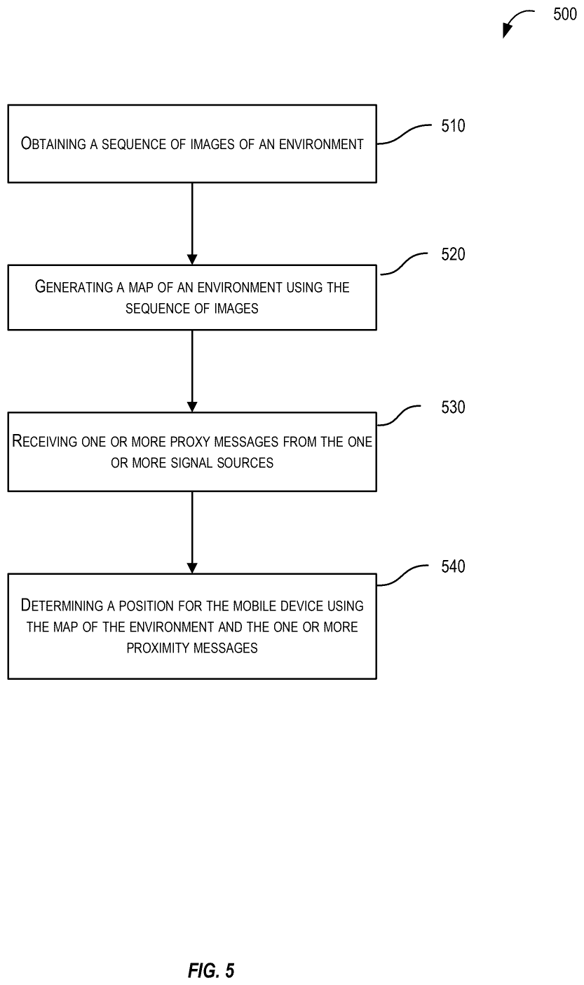

A mobile device that can perform VIO techniques may use the spatial map (e.g., a SLAM map) to locate the device in a physical location. Locating the device using VIO techniques may be more accurate, but locating the mobile device using proximity message may be more computationally efficient. FIG. 5 shows techniques for locating a VIO enabled mobile device.

FIG. 5 is a flowchart illustrating a method 500 for performing spatial localization with a VIO enabled device according to various embodiments. In some implementations, one or more method blocks of FIG. 5 may be performed by a mobile device (e.g., device 900). In some implementations, one or more method blocks of FIG. 5 may be performed by another device or a group of devices separate from or including the mobile device. Additionally, or alternatively, one or more method blocks of FIG. 5 may be performed by one or more components of the mobile device, such as processor 918, computer readable memory 902, camera 944, sensors 946, etc.

At block 510, a sequence of images of an environment can be obtained. For instance, the images be captured by an image of the device, or the image can be provided to the device (e.g., from an external camera). Inertial measurements can be captured with the sequence of images. The framerate at which the sequence of images is captured can vary based on the battery capacity of the mobile device (e.g., the amount of remaining energy stored in the battery).

At block 520, a map of the environment can be generated using the sequence of images. The map can include one or more walls and one or more signal sources. The map can be generated using SLAM techniques described above in section II. Positions on the map can be measured relative to an origin of the map which can be the position at which a device began to generate the map. Features can be captured in sequential images and the mobile device's pose (e.g., its position relative to the features identified in the image) can be determined based on the apparent movement of the features across images. Generating the map can include determining any loop closures by determining two or more non-sequential images in the sequence of images that contain a number of overlapping features (e.g., features in both images) that are above an overlapping feature threshold (e.g., a number of features that are present in both images; a threshold number). Once the two or more images have been determined, the poses corresponding to each image can be identified as corresponding to the same location.

In some embodiments, the device capturing the images, and the device generating the map can be separate. For example, the images may be captured by a peripheral device that is communicably coupled with a device generating the map. The device capturing images may not have sufficient processing power to generate a map, and these images can be shared with a device that is capable of generating the map. For example, the images can be shared by a wired connection, a peer to peer connection (e.g., a near field communication (NFC) connection), a personal area network (PAN) connection (e.g., Bluetooth), a local area network (e.g., a WiFi network), or a wide area network (e.g., the internet). In some embodiments, the device capturing the images and the device generating the map may be collocated in the environment being mapped (e.g., a camera and a personal computer) or the two devices may be in separate locations (e.g., a camera and a server computer).

At block 530, one or more proximity messages can be received from the one or more signal sources. The one or more proximity messages can be received at the mobile device. The proximity messages can be used to calculate the distance between the mobile device and one or more of the signal sources. The proximity message may be used to determine the mobile device's position and orientation with respect to the signal sources.

At block 540, a position for the mobile device can be determined using the map of the environment and the one or more proximity messages. Determining the position can include capturing an image using the camera of the mobile device. The image can be provided as input to a combined prediction framework. A position estimate can be output from the combined prediction framework, and the position estimate can be identified as the position for the mobile device.

The techniques to determine the position of a mobile device can vary based on the battery capacity of the mobile device. For example, the mobile device can compare a battery capacity of the mobile device to a battery threshold. If the battery capacity exceeds a battery threshold (e.g., a threshold charge in the battery), the mobile device can determine the position for the mobile device using the map of the environment. If the battery capacity does not exceed the battery threshold, the mobile device can determine the position of the mobile device using proximity messages.

Method 500 may include additional implementations, such as any single implementation or any combination of implementations described below and/or in connection with one or more other processes described elsewhere herein.

Although FIG. 5 shows example blocks of method 500, in some implementations, method 500 may include additional blocks, fewer blocks, different blocks, or differently arranged blocks than those depicted in FIG. 5. Additionally, or alternatively, two or more of the blocks of method 500 may be performed in parallel.

### IV. Device Constellations for Spatial Localization

It may be advantageous to share information about a physical location between devices. A device with this information may be able to identify a correspondence between a sensor value and a physical location more accurately without having to generate a map of the device's current environment. However, a map that was created using visual odometry techniques may include personal information that users may not want to share. Instead of sharing the map, the device can share the relative positions of the signal sources. These relative positions, called a device constellation, can allow a recipient device to improve accuracy without exposing potentially sensitive personal information.

### A. Determining a Device Constellation

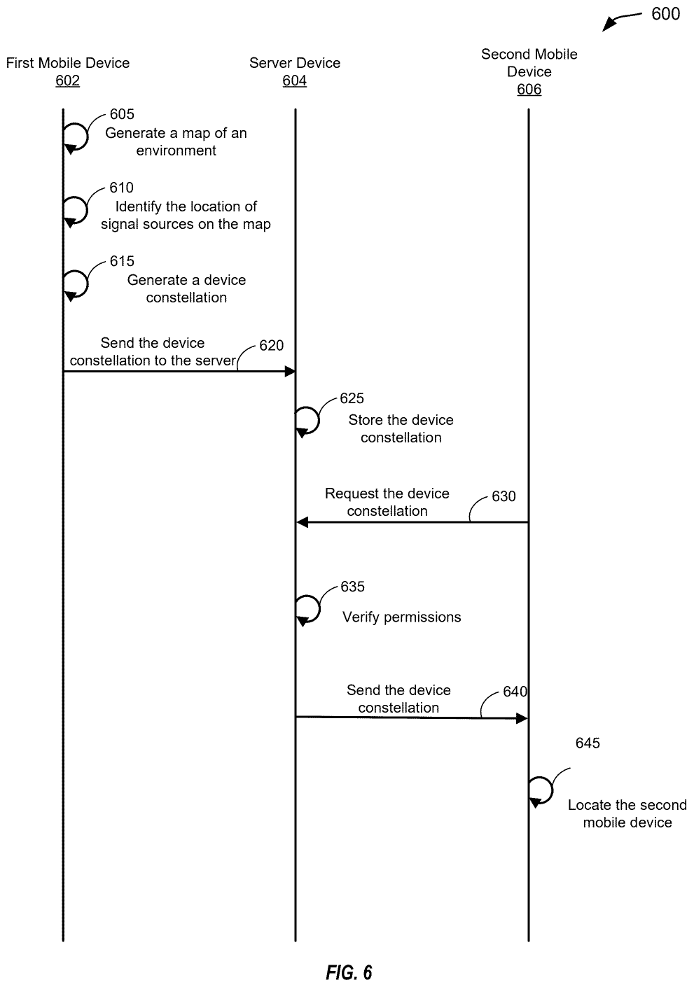

FIG. 6 is a simplified sequence diagram showing the creation, storage, and use of a device constellation according to various embodiments. The device constellation can be a set of three-dimensional coordinates that identify the relative positions of the signal sources. The device constellation can be determined by identifying the location of signal sources in a map of an environment. Turning to FIG. 6 in greater detail, a first mobile device 602 can generate a map of an environment at 605. The position in three-dimensional space can be determined for each signal source using the map which can be generated using SLAM techniques. Once the map has been generated for the environment, each signal source can be identified on the map at 610 using first mobile device 602. For instance, first mobile device 602 may be placed on each signal source to identify each signal source's position.

Once the position for each signal source is determined, the first mobile device 602 can generate the device constellation at 615 by calculating the distances between the signal sources. These distances can be calculated by one or more of the signal sources using the device constellation, or server device 604. The distances can be calculated relative to an origin of the SLAM map. The distance can be represented by coordinates on a common coordinate system (e.g., a device constellation). For example, a first signal source can be assigned as the origin in an x,y,z coordinate system (e.g., (0 meters (m), 0 m, 0 m)). The other signal sources can be assigned three dimensional coordinates relative to the first signal source (e.g., (3.5 m, 2 m, −6 m)). The device constellation may be a set of vectors with each vector in the set pointing from one signal source to another signal source. The coordinate system may use the origin of the SLAM map as the origin in the x,y,z coordinate system. This common coordinate system can be used to calibrate distances in ranging measurements and to perform other functionality. In some embodiments, the common coordinate system can include coordinates for one or more of the microlocations identified in the environment. In addition, the common coordinate system can include path information, and, for instance, a signal source can be stored with the distance from that source to the signal sources and microlocations in the environment corresponding to the coordinate system. The device constellation may also include any confidence scores generated for ranging messages with a particular set of characteristics.

### B. Sharing the Device Constellation Between Devices

The device constellation can be shared between devices. Some devices may not be capable of performing SLAM techniques and generating their own common coordinate system. In addition, generating a SLAM map and a common coordinate system can be energy intensive and it may be advantageous to share the coordinates between devices even if those devices are individually capable of generating common coordinates. At 620, the coordinate system can be stored in server device 604 and associated with the first mobile device 602 that generated the map (e.g., associated with a device identifier or an account identifier for an account that is signed into the device). The server device 604 can be one or more of the signal sources in some embodiments. The first mobile device 602 may share the device constellation directly to the second mobile device 606 via a peer-to-peer connection in some embodiments. The device constellation, with the coordinates, may be requested from a server at 630 by a second mobile device 606.

At 635 server device 604 can verify whether second mobile device 606 has permission to access the device constellation. For instance, accounts that are in the contacts list for the device that generated the map may have permission to access the coordinate system. The account that generated the map (e.g., an account associated with first mobile device 602) can configure the permissions dictating which devices and accounts can access the coordinate system. In addition, the permissions can control the terms under which a device can access the coordinate system. For instance, permissions may dictate that a device can only locally store the coordinate system for 72 hours or the coordinate system may only be locally stored by devices that are in a geofenced area around the location corresponding to the coordinate system (e.g., the coordinate system is downloaded upon entering the geofenced area and deleted upon leaving the geofenced area). In some embodiments, second mobile device 606 may be able to retrieve a coordinate system from a server using information from a ranging message's payload. For instance, a signal source may include a source identifier corresponding to the source. Second mobile device 606 can provide this identifier to the server device 604 storing the coordinate system and the server at 640 can return any coordinate system associated with the identifier.

The coordinate system may be stored locally in a mobile device or a signal source. For example, a signal source can store a copy of a coordinate system and this system can be provided in the payload of ranging measurements sent by the source. For example, a signal source can include vectors pointing to the positions of any other signal sources in the payload of the source's ranging measurements. The coordinate system may be stored locally in the device that generated the coordinate system. The device can share this coordinate system with nearby devices via a peer-to-peer message such as a near-field communication (NFC) message.

### C. Spatial Localization Using the Device Constellation

A device receiving the common coordinate system, also called a device constellation, can use the relative positions of the signal sources to locate a mobile device in the physical space corresponding to the system. The relative position of signal sources, and microlocations, can provide more information that a mobile device can use to determine its location in the physical space.

1. Devices without VIO Capabilities

A device constellation can be used to locate a mobile device that cannot perform visual-inertial odometry or SLAM techniques. Returning to FIG. 6, second mobile device 606 can use the common coordinates and other device sensor measurements to locate the device at 645. For example, second mobile device 606 can use the common coordinates to determine the orientation of second mobile device 606. For example, the second mobile device 606 can use inertial measurements to determine if the device is moving and the type of motion. The second mobile device 606 may determine from inertial measurements that the device is rotating or that the device has moved laterally. This inertial information can be used in conjunction with ranging messages and the device constellation to locate the second mobile device 606 in an environment.

The second mobile device 606 can use the device constellation to determine the device's orientation and location more precisely than would be possible by dead reckoning. Dead reckoning can be the process of determining a device's position using the distance and direction that the device has traveled. Dead reckoning is dependent on the accuracy of the record of the device's position, and errors in one measurement are propagated to future position determinations because all subsequent positions are determined in relation to previous position determinations. A device constellation can provide known points of reference so that the second mobile device 606 can determine its position relative to known landmarks and not to previous position determinations.

In an example, the second mobile device 606 is located between two signal sources and, during rotation, the received signal strength for ranging measurements from each source fluctuates. A human can absorb energy from the signal as it passes through the body. This information, and the fluctuating signal strength, can be used to determine the orientation of the second mobile device 606 with respect to the known signal source locations. For instance, a device can determine that a magnitude of a first signal measurement corresponding to a first signal source is high while a magnitude of a second signal measurement corresponding to a second signal source is low. Inertial sensors on the device can show that the second mobile device 606 has rotated, and now the magnitude of the first signal measurement is low while the magnitude of the second signal source is high. Without the inertial measurements, a location tracking algorithm executing on the second mobile device 606 may determine that the mobile device's distance from the first signal source has decreased and the distance from the second signal source has increased.

Instead of relying on the inertial sensors for an angle of rotation, the inertial sensors may be used to determine that the second mobile device 606 is rotating, and the precise orientation is determined using sensor values from the signal sources. The orientation information, and the known positions of the signal sources and microlocations can be used with inertial measurements to track a device's position between microlocations. Once the second mobile device 606 has been located at a signal source or microlocation, the orientation of the device can be determined using the inertial measurements and ranging messages as described above. As the second mobile device 606 moves from one known location to another, the inertial measurements can be used to determine the device's displacement in the environment and the orientation information can be used to determine the direction of travel. Once the second mobile device 606 reaches its destination, the position of a stationary mobile device can be determined using ranging measurements and this position can be refined overtime as the device stays stationary. Unlike in dead reckoning, any errors in the moving device's location can be corrected when the device becomes stationery and position errors are not necessarily propagated.

### 2. VIO Enabled Devices

A device that is capable of performing visual-inertial odometry techniques can use the device constellation to reduce the computational and energy cost of locating the device. For example, the second mobile device 606 may not be capable of performing SLAM or VIO techniques. A mobile device that can perform VIO techniques, or SLAM techniques, can use the odometry techniques to track the device's location in an environment. However, performing visual odometry can require capturing and processing a large amount of visual information. For instance, a device performing 15 minutes of VIO with a 60 Hertz (Hz) camera will have to process 900 images.

The second mobile device 606, by using a device constellation to determine its location, can reduce the device's memory, processor, and battery utilization. Instead of continuously tracking the device's position with VIO techniques, the second mobile device 606 can use location techniques in section IV.C.1 to track the mobile device's movement through the environment. If the second mobile device 606 loses track of its location, or the constellation becomes unreliable because of movement or failure of a signal source, the mobile device can use VIO techniques to map the environment and locate the device within the map.

### D. Methods for Common Coordinate Spatial Localization

A device constellation can be used as a common coordinate system to assist a mobile device in navigating an environment. The techniques described below can be used to generate a device constellation and locate a mobile device using the device constellation.

### 1. Determining a Device Constellation

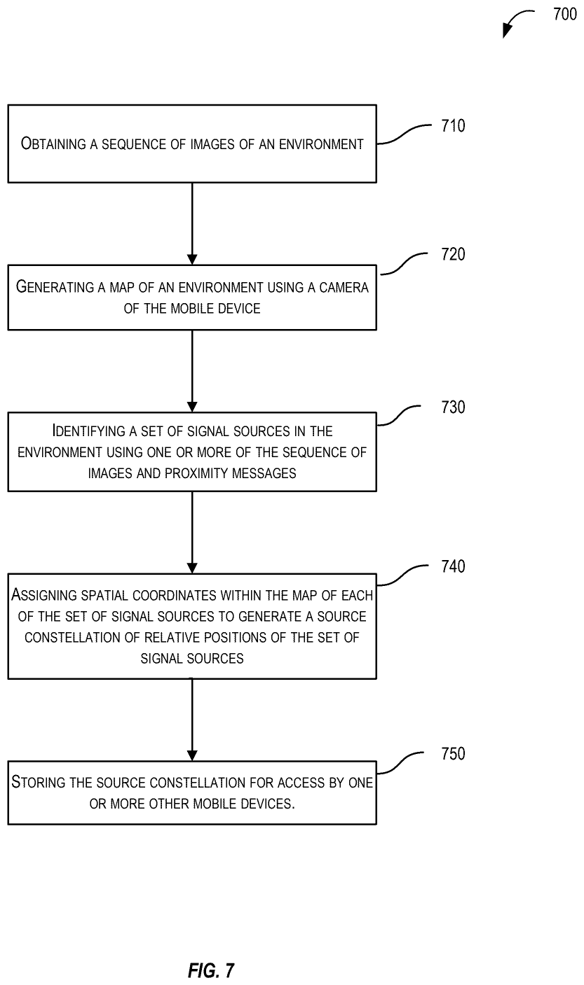

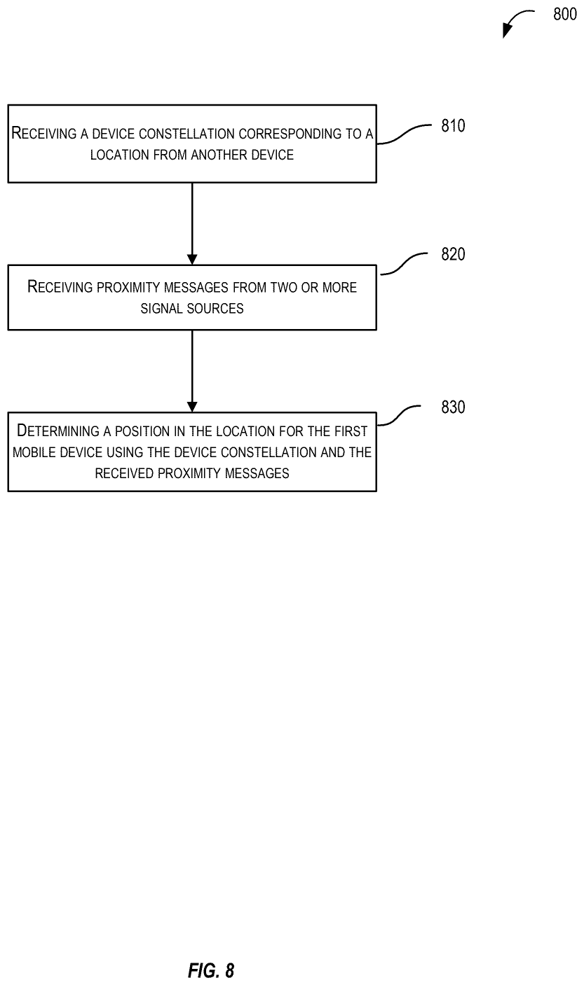

A mobile device can use captured images to determine a map of an environment. The mobile device can identify signal sources within the map and the device can determine a device constellation by calculating the distance between sources. This constellation can be used to locate the device in the environment corresponding to the map. In addition, the map can be shared with other devices so that they can locate their position in the environment. FIG. 7 describes techniques for generating and sharing a device constellation.

FIG. 7 is a flowchart illustrating a method 700 for determining a device constellation according to various embodiments. In some implementations, one or more method blocks of FIG. 7 may be performed by a mobile device (e.g., device 900). In some implementations, one or more method blocks of FIG. 7 may be performed by another device or a group of devices separate from or including the mobile device. Additionally, or alternatively, one or more method blocks of FIG. 7 may be performed by one or more components of the mobile device, such as processor 918, computer readable memory 902, camera 944, sensors 946, etc.

At block 710, a sequence of images of an environment can be obtained by the device. For example, the images can be captured by a camera of a mobile device, or the images can be captured by a camera of an external electronic device and provided to the device (e.g., via a personal area network, a peer to peer network, a wired connection, etc.). Inertial measurements can be captured with the sequence of images. The framerate at which the sequence of images is captured can vary based on the battery capacity of the mobile device (e.g., the amount of remaining energy stored in the battery; whether the battery capacity is above or below a battery threshold).

At block 720, a map of an environment can be generated using the sequence of images. The map can be generated using SLAM techniques described above in section II. Features can be captured in sequential images and the mobile device's pose (e.g., its position relative to the features identified in the image) can be determined based on the apparent movement of the features across images. Generating the map can include determining any loop closures by determining two or more non-sequential images in the sequence of images that contain a number of overlapping features (e.g., features in both images) that are above an overlapping feature threshold (e.g., a number of features that are present in both images; a threshold number). Once the two or more images have been determined, the poses corresponding to each image can be identified as corresponding to the same location.

At block 730, a set of signal sources in the environment can be identified. The signal sources can be identified using one or more of the sequence of images and the proximity messages. The proximity messages can be exchanged between the mobile device and the set of signal sources. The payload of the proximity messages can include a unique identifier associated with the device transmitting the message. The proximity message can be a ranging message. In some embodiments, the payload of the proximity message can include information indicating whether the signal source transmitting the message has been moved. For example, the message can indicate whether the device has been moved between signal transmissions or information identifying the time and date when the signal source was last moved.

At block 740, spatial coordinates within the map can be assigned to each of the set of signal sources to generate a source constellation. The source constellation can be a list of the relative positions of the signal sources. The source constellation for a signal source can be vectors identifying the location of any signal sources that are within range of the signal source. A signal source can be in range of another signal source if the two sources can exchange proximity messages. Spatial coordinates can be assigned to each signal source by determining that the mobile device is within a threshold distance of a signal source. A signal source that is within the threshold distance can be a proximate signal source. The distance between the mobile device and the signal source can be determined using proximity messages or VIO techniques. The position in the map for the proximate signal source can be determined by providing an image captured by the mobile device as input to a combined prediction framework (e.g., as described in section II). Inertial measurements can be provided to the combined prediction framework in some embodiments. A position estimate corresponding to the mobile device's current location can be output from the combined prediction framework. The coordinates corresponding to the position estimate can be assigned to the signal source. In some embodiments, spatial coordinates can be assigned to microlocations identified in the environment. The spatial coordinates of the microlocations can be included in the source constellation.

At block 750, the source constellation can be stored for access by one or more other mobile devices. The source constellation can be stored in a server that is accessible via a network connection. The source constellation can be stored locally in the mobile device. The mobile device can instruct a signal source to store the device constellation. The device constellation can be stored with permissions that dictate which devices can access the device constellation.

In some implementations, the mobile device can be located using the source constellation. The device can be located by exchanging proximity messages between the mobile device and one or more of the signal sources.

Method 700 may include additional implementations, such as any single implementation or any combination of implementations described below and/or in connection with one or more other processes described elsewhere herein.

Although FIG. 7 shows example blocks of method 700, in some implementations, method 700 may include additional blocks, fewer blocks, different blocks, or differently arranged blocks than those depicted in FIG. 7. Additionally, or alternatively, two or more of the blocks of method 700 may be performed in parallel.

2. Spatial Localization Using a Device without VIO Capabilities

A mobile device may not be able to perform SLAM or VIO techniques. Such a device may not be able to produce a device constellation, but the device may be able to navigate using proximity messages. Such devices may retrieve a device constellation, produced by a VIO or SLAM enabled device, and the device can locate its position in the corresponding environment using the device constellation. FIG. 8 shows techniques for locating a device that is not VIO or SLAM capable using a device constellation.

FIG. 8 is a flowchart illustrating a method 800 for performing antenna tuning according to various embodiments. In some implementations, one or more method blocks of FIG. 8 may be performed by a mobile device (e.g., device 900). In some implementations, one or more method blocks of FIG. 8 may be performed by another device or a group of devices separate from or including the mobile device. Additionally, or alternatively, one or more method blocks of FIG. 8 may be performed by one or more components of the mobile device, such as processor 918, computer readable memory 902, camera 944, sensors 946, etc.

At block 810, a device constellation corresponding to a location can be received at a mobile device. The device constellation can be received from another device. The device constellation may have been previously generated by a second mobile device at the location. The first mobile device and the second mobile device may be the same type of mobile device. The first mobile device and the second mobile device may be the same type of mobile device if the two devices have the same hardware configuration and the same software configuration (e.g., the same hardware components and the same software versions). The software configuration of the first mobile device and the second mobile device may be the same if the operating system and firmware are the same in each device (e.g., the same type and version).

Receiving the device constellation can involve sending a request identifying the device constellation to a device constellation server and receiving the device constellation in response to the request. The request can include a device type identifier associated with the first mobile device (e.g., a serial number, a model number, a software version, an international mobile equipment identity (IMEI) number, an account number, etc.) and a location identifier (e.g., longitude and latitude values, a street address, an internet protocol address, a media access control address for one or more electronic devices on a network, etc.). The source constellation can be received from a server, a mobile device, or a signal source via network connection. The source constellation can be received from a signal source in the payload of a proximity message.

At block 820, proximity messages from two or more signal sources can be received. A proximity message may indicate that the signal source has moved. The message may identify a time when the signal source was moved, and the device constellation may indicate a time when the constellation was generated or last updated. A signal source can be removed from the device constellation to produce an updated device constellation if the time when the deice was moved is later than the time when the device constellation was generated or last updated. The updated device constellation can comprise a set of remaining signal sources. After the updated device constellation was produced, proximity messages from the remaining signal sources can be received, and a position in the location for the first mobile device using the updated device constellation and the second received proximity messages.

At block 830, a position in the location can be determined for the first mobile device. The position can be determined using the device constellation and the received proximity messages. If an updated device constellation was produced at 820, whether a number of messages in the second received proximity messages is below a threshold can be determined. In such circumstances, the mobile device may indicate that a position cannot be determined. The threshold can be 1 signal source, 2 signal sources, 3 signal sources, 4 signal sources, 5 signal sources, or 6 signal sources.

Method 800 may include additional implementations, such as any single implementation or any combination of implementations described below and/or in connection with one or more other processes described elsewhere herein.

Although FIG. 8 shows example blocks of method 800, in some implementations, method 800 may include additional blocks, fewer blocks, different blocks, or differently arranged blocks than those depicted in FIG. 8. Additionally, or alternatively, two or more of the blocks of method 800 may be performed in parallel.

### V. Example Device

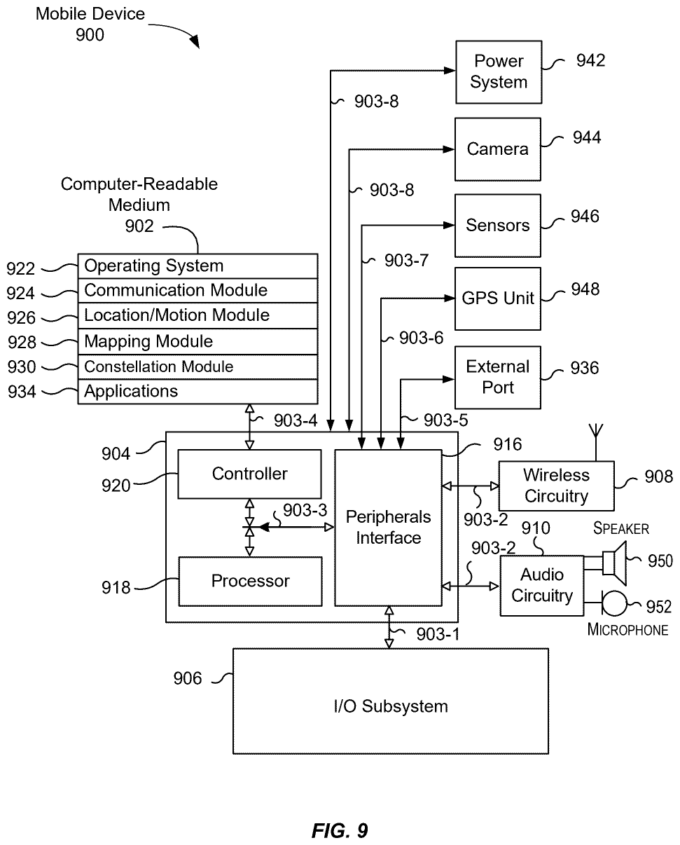

FIG. 9 is a block diagram of an example device 900, which may be a mobile device or a computing device. Device 900 generally includes computer-readable medium 902, a processing system 904, an Input/Output (I/O) subsystem 906, wireless circuitry 908, and audio circuitry 910 including speaker 950 and microphone 952. These components may be coupled by one or more communication buses or signal lines 903. Device 900 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 9 is only one example of an architecture for device 900, and that device 900 can have more or fewer components than shown, or a different configuration of components. The various components shown in FIG. 9 can be implemented in hardware, software, or a combination of both hardware and software, including one or more signal processing and/or application specific integrated circuits.

Wireless circuitry 908 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 908 can use various protocols, e.g., as described herein.

Wireless circuitry 908 is coupled to processing system 904 via peripherals interface 916. Interface 916 can include conventional components for establishing and maintaining communication between peripherals and processing system 904. Voice and data information received by wireless circuitry 908 (e.g., in speech recognition or voice command applications) is sent to one or more processors 918 via peripherals interface 916. One or more processors 918 are configurable to process various data formats for one or more application programs 934 stored on medium 902. Wireless circuitry 908 can be used to exchange ranging messages (e.g., proximity messages) with one or more electronic devices. The processor 918 can calculate distances to devices transmitting ranging messages using messages received at wireless circuitry 908.

Peripherals interface 916 couple the input and output peripherals of the device to processor 918 and computer-readable medium 902. One or more processors 918 communicate with computer-readable medium 902 via a controller 920. Computer-readable medium 902 can be any device or medium that can store code and/or data for use by one or more processors 918. Medium 902 can include a memory hierarchy, including cache, main memory, and secondary memory.

Device 900 also includes a power system 942 for powering the various hardware components. Power system 942 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management, and distribution of power in mobile devices.

In some embodiments, device 900 includes a camera 944. In some embodiments, device 900 includes sensors 946. Sensors 946 can include accelerometers, compasses, gyrometers, pressure sensors, audio sensors, light sensors, barometers, and the like. Sensors 946 can be used to generate inertial measurement and measure the movement of device 900. Sensors 946 can be used to sense location aspects, such as auditory or light signatures of a location.

In some embodiments, device 900 can include a GPS receiver, sometimes referred to as a GPS unit 948. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 900 may be configured to identify GLONASS signals, or any other similar type of satellite navigational signal.

One or more processors 918 run various software components stored in medium 902 to perform various functions for device 900. In some embodiments, the software components include an operating system 922, a communication module (or set of instructions) 924, a location module (or set of instructions) 926, a triggering event module 928, a predicted app manager module 930, and other applications (or set of instructions) 934, such as a car locator app and a navigation app.

Operating system 922 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 924 facilitates communication with other devices over one or more external ports 936 or via wireless circuitry 908 and includes various software components for handling data received from wireless circuitry 908 and/or external port 936. External port 936 (e.g., USB, FireWire, Lightning connector, 60-pin connector, etc.) is adapted for coupling directly to other devices or indirectly over a network (e.g., the Internet, wireless LAN, etc.).

Location/motion module 926 can assist in determining the current position (e.g., coordinates or other geographic location identifier) and motion of device 900. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 926 receives data from GPS unit 948 and analyzes the signals to determine the current position of the mobile device. In some embodiments, location/motion module 926 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 908 and is passed to location/motion module 926. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 900 based on the position coordinates of the corresponding transmitters. Regardless of the specific location technology used, location/motion module 926 receives information from which a location fix can be derived, interprets that information, and returns location information, such as geographic coordinates, latitude/longitude, or other location fix data.

Mapping module 928 can include various sub-modules or systems. Mapping module 928 can use images from camera 944 to perform visual odometry techniques, visual inertial odometry techniques, and SLAM techniques. Furthermore, constellation module 930 can include various sub-modules or systems. The constellation module 930 can identify and extract signal sources and microlocations from maps generated by mapping module 928.

The one or more application programs 934 on the mobile device can include any applications installed on the device 900, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 906 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 906 can include a display and user input devices such as a keyboard, mouse, and/or track pad. In some embodiments, I/O subsystem 906 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 902) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 900 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A computer implemented method comprising, performing by a mobile device:
obtaining a sequence of images of an environment;
generating a map of the environment using the sequence of images, the map including one or more walls and one or more signal sources;
receiving one or more proximity messages from the one or more signal sources; and
determining a position for the mobile device using the map of the environment and the one or more proximity messages.

2. The method of claim 1, wherein the determining comprises:
comparing a battery capacity of the mobile device to a battery threshold;
responsive to the battery capacity exceeding the battery threshold, determining the position for the mobile device using the map of the environment; and
responsive to the battery capacity not exceeding the battery threshold, determining the position of the mobile device using the one or more proximity messages.

3. The method of claim 2, wherein determining the position for the mobile device using the map of the environment comprises:
capturing an image using a camera of the mobile device;
providing the image as input to a combined prediction framework;
receiving a position estimate as output from the combined prediction framework; and
identifying the position estimate as the position for the mobile device.

4. The method of claim 1, wherein generating the map of the environment comprises:
identifying features in each image of the sequence of images;
determining a corresponding location for each image of the sequence of images;
determining two or more images in the sequence of images that include a threshold number of features that are present in each of the two or more images;
updating the corresponding location of each of the two or more images; and
generating the map of the environment.

5. The method of claim 2, wherein determining the position for the mobile device using the map of the environment comprises:
receiving an image from a peripheral device that is communicably coupled with the mobile device;
providing the image as input to a combined prediction framework;
receiving a position estimate as output from the combined prediction framework; and
identifying the position estimate as the position for the mobile device.

6. The method of claim 1, wherein the sequence of images is obtained by:
capturing the sequence of images by a camera of the mobile device.

7. The method of claim 1, wherein the sequence of images is obtained by:
receiving the sequence of images from a peripheral device that is communicably coupled with the mobile device.

8. A computing device, comprising:
one or more memories; and
one or more processors in communication with the one or more memories and configured to execute instructions stored in the one or more memories to perform operations to:
obtain a sequence of images of an environment;
generate a map of the environment using the sequence of images, the map including one or more walls and one or more signal sources;
receive one or more proximity messages from the one or more signal sources; and
determine a position for a mobile device using the map of the environment and the one or more proximity messages.

9. The computing device of claim 8, wherein the operations to determine the position for the mobile device comprise operations to:
compare a battery capacity of the mobile device to a battery threshold;
responsive to the battery capacity exceeding the battery threshold, determine the position for the mobile device using the map of the environment; and
responsive to the battery capacity not exceeding the battery threshold, determine the position of the mobile device using the one or more proximity messages.

10. The computing device of claim 9, wherein determining the position for the mobile device using the map of the environment comprises operations to:
capture an image using a camera of the mobile device;
provide the image as input to a combined prediction framework;
receive a position estimate as output from the combined prediction framework; and
identify the position estimate as the position for the mobile device.

11. The computing device of claim 8, wherein generating the map of the environment comprises operations to:
identify features in each image of the sequence of images;
determine a corresponding location for each image of the sequence of images;
determine two or more images in the sequence of images that include a threshold number of features that are present in each of the two or more images;
update the corresponding location of each of the two or more images; and
generate the map of the environment.

12. The computing device of claim 9, wherein determining the position for the mobile device using the map of the environment comprises operations to:
receive an image from a peripheral device that is communicably coupled with the mobile device;
provide the image as input to a combined prediction framework;
receive a position estimate as output from the combined prediction framework; and
identify the position estimate as the position for the mobile device.

13. The computing device of claim 8, wherein the sequence of images is obtained by operations to:
capture the sequence of images by a camera of the mobile device.

14. The computing device of claim 8, wherein the sequence of images is obtained by operations to:
receive the sequence of images from a peripheral device that is communicably coupled with the mobile device.

15. A non-transitory computer-readable medium storing a plurality of instructions that, when executed by one or more processors of a computing device, cause the one or more processors to perform operations to:
obtain a sequence of images of an environment;
generate a map of the environment using the sequence of images, the map including one or more walls and one or more signal sources;
receive one or more proximity messages from the one or more signal sources; and
determine a position for a mobile device using the map of the environment and the one or more proximity messages.

16. The non-transitory computer-readable medium of claim 15, wherein the operations to determine the position for the mobile device comprise operations to:
compare a battery capacity of the mobile device to a battery threshold;
responsive to the battery capacity exceeding the battery threshold, determine the position for the mobile device using the map of the environment; and
responsive to the battery capacity not exceeding the battery threshold, determine the position of the mobile device using the one or more proximity messages.

17. The non-transitory computer-readable medium of claim 16, wherein determining the position for the mobile device using the map of the environment comprises operations to:
capture an image using a camera of the mobile device;
provide the image as input to a combined prediction framework;
receive a position estimate as output from the combined prediction framework; and
identify the position estimate as the position for the mobile device.

18. The non-transitory computer-readable medium of claim 15, wherein generating the map of the environment comprises operations to:
identify features in each image of the sequence of images;
determine a corresponding location for each image of the sequence of images;
determine two or more images in the sequence of images that include a threshold number of features that are present in each of the two or more images;
update the corresponding location of each of the two or more images; and
generate the map of the environment.

19. The non-transitory computer-readable medium of claim 16, wherein determining the position for the mobile device using the map of the environment comprises operations to:
receive an image from a peripheral device that is communicably coupled with the mobile device;
provide the image as input to a combined prediction framework;
receive a position estimate as output from the combined prediction framework; and
identify the position estimate as the position for the mobile device.

20. The non-transitory computer-readable medium of claim 15, wherein the sequence of images is obtained by operations to:
capture the sequence of images by a camera of the mobile device.
